(19) United States
(12) Patent Application Publication
(10) Pub. No.: US 2012/0150701 A1
(43) Pub. Date: Jun. 14, 2012

(54) Hierarchical Processing of Tolling Options for Telematics Services

(75) Inventors: James W. Leyerle, Pleasant Ridge, MI (US); Steven Swanson, Commerce Township, MI (US)

(73) Assignee: General Motors LLC, Detroit, MI (US)

(21) Appl. No.: 12/962,872

(22) Filed: Dec. 8, 2010

(51) Int. Cl. G06Q 30/00

(52) U.S. Cl. 705/30

(57) ABSTRACT

The described method and system provide a system and method for efficiently and effectively processing the hierarchical selecting and switching between tolling options associated with a telematics service and tolling a subscriber's account accordingly such that the provision of telematics service to a user of the telematics unit is uninterrupted if possible and the optimal tolling option is utilized. Many different types of telematics services exists, and each telematics service may have a corresponding set of tolling options, including various telematics-based (internal) and network-based (external) tolling options, prepaid and postpaid tolling options, as well as other types of tolling options. The disclosed invention allows the telematics service system to select an optimal tolling option and switch between tolling options without interrupting the provision of service based on a hierarchy of tolling options corresponding to the telematics service requested by the user.

### BACKGROUND OF THE INVENTION

Telematics units within mobile vehicles provide subscribers with connectivity to a telematics service provider (TSP). The TSP provides the subscriber with an array of services ranging from emergency call handling and stolen vehicle recovery to diagnostics monitoring and turn-by-turn navigation. Telematics units are often provisioned and activated at a point of sale when a subscriber purchases a telematics-equipped vehicle. Upon activation, the telematics unit can be utilized to provide a subscriber with the telematics services.

In some instances, a free trial subscription to certain telematics-related services may be provided in combination the vehicle purchase, e.g., a certain amount of “subscription minutes” to a service such as a hands-free calling service, an amount of free data transfer over a network, or an unlimited subscription to a service for a set time period, such as a 1-year subscription to an emergency call handling service.

TSPs may contract with and work with telecommunications network providers or internet service providers to make these various different telematics-based services available to subscribers. However, with many different possible service plans, such as plans for hands-free calling, movie downloads, turn-by-turn navigation, etc., and different possible terms and implementation options for various plans, it may be difficult to toll (i.e. deduct) “subscription minutes” from an appropriate plan without simultaneously tolling subscription minutes from a different plan, or switch from tolling from one plan to the other when the first plan runs out of “subscription minutes.” Further complicating matters is that certain plans may be prepaid and others may be postpaid, and certain plans may be tolled by the telematics unit itself (i.e. “telematics-based” or “internal”) and others may be tolled by an outside network (i.e. “network-based” or “external”).

Having numerous types of plans and payment options may create certain service problems. For example, customers may find their service cut off when their subscription to one plan expires or runs out of subscription minutes or data allocation, when in fact there are alternative tolling options available that may be utilized to cover their desired service. Additionally, a subscriber's account may be incorrectly tolled using one payment method when it could have been more cost-effectively tolled using another payment method (e.g., subtracting “subscription minutes” from one plan when the customer also has an unlimited monthly subscription plan in effect; or, in another example, tolling subscription minutes with a later expiration under one type of payment plan when subscription minutes with an earlier expiration under the same type of payment plan could have been tolled). In yet another example, a subscriber's account may be erroneously tolled simultaneously under multiple plans for one service where the multiple plans are all capable of implementing that one service.

Thus, it is an object in part to provide a system and method for efficiently and effectively switching between various plans and between telematics-based and network-based tolling such that the provision of telematics service is uninterrupted if possible and the optimal tolling option is utilized. However, while this is an object underlying certain implementations of the invention, it will be appreciated that the invention is not limited to systems that solve the problems noted herein. Moreover, the inventors have created the above body of information for the convenience of the reader and expressly disclaim all of the foregoing as prior art; the foregoing is a discussion of problems discovered and/or appreciated by the inventors, and is not an attempt to review or catalog the prior art.

### BRIEF SUMMARY OF THE INVENTION

The invention provides a system and method for efficiently and effectively processing the hierarchical selecting and switching between tolling options associated with a telematics service and tolling a subscriber's account accordingly. In one implementation, the TSP may establish and provide to the telematics unit a hierarchy of tolling options based on the available payment plans for telematics services, and may further establish different hierarchies corresponding to different particular telematics services. In an alternative implementation, the telematics unit may generate a hierarchy or hierarchies of tolling options based on information provided by the TSP. Based on this hierarchy or these hierarchies, the telematics unit may select an appropriate tolling option and ensure that the subscriber's account is only tolled according to that tolling option. In further implementations, the telematics units may switch to and from prepaid plans and postpaid plans or telematics-based tolling and network-based tolling.

In a further implementation, upon determining that the first tolling option selected is no longer viable to maintain the operation of the service (e.g. when a subscriber runs out of “subscription minutes” to a certain service), the telematics unit may determine if there are alternative tolling options available, and if so, may continue providing the service to the user of the telematics unit without interruption by switching to an alternative tolling option. The alternative tolling option that the telematics unit switches to may be the next available tolling option based on the previously generated hierarchy.

In yet another further implementation, the telematics unit may notify the user of the first tolling option that it selected. The first tolling option the telematics unit selects may be the tolling option with the highest position in the hierarchy that is activated and has sufficient balance to initiate the service. The telematics unit may further notify the user when the first tolling option it selected is insufficient to maintain the requested service and may notify the user that it is switching to another tolling option. The telematics unit may further give the user the option to decline switching to another tolling option. In yet another further implementation, the TSP may designate a certain tolling option or multiple options as “default” tolling options such that the telematics unit 304 may select any of the default tolling options without user approval.

Other objects and advantages of the invention will become apparent upon reading the following detailed description and upon reference to the drawings.

### BRIEF DESCRIPTION OF THE SEVERAL VIEWS OF THE DRAWINGS

FIG. 1 is a schematic diagram of an operating environment for a mobile vehicle communication system usable in implementations of the described principles;

FIG. 2 is a flowchart illustrating a process for choosing a tolling option out of a hierarchy of different methods and switching between tolling options without interrupting service on a telematics unit;

FIG. 3 is a flowchart illustrating a process, in one implementation, for switching between various different tolling options given a particular set of parameters; and;

FIG. 4 is a flowchart illustrating a process, in another implementation, for switching between various different tolling options given a different particular set of parameters than that of the implementation in FIG. 3.

### DETAILED DESCRIPTION OF THE INVENTION

Before discussing the details of the invention and the environment wherein the invention may be used, a brief overview is given to guide the reader. In general terms, not intended to limit the claims, the invention is directed to a system and method for efficiently and effectively processing the hierarchical selecting and switching between tolling options associated with a telematics service and tolling a subscriber's account accordingly such that the provision of telematics service to a user of the telematics unit is uninterrupted if possible and the optimal tolling option is utilized.

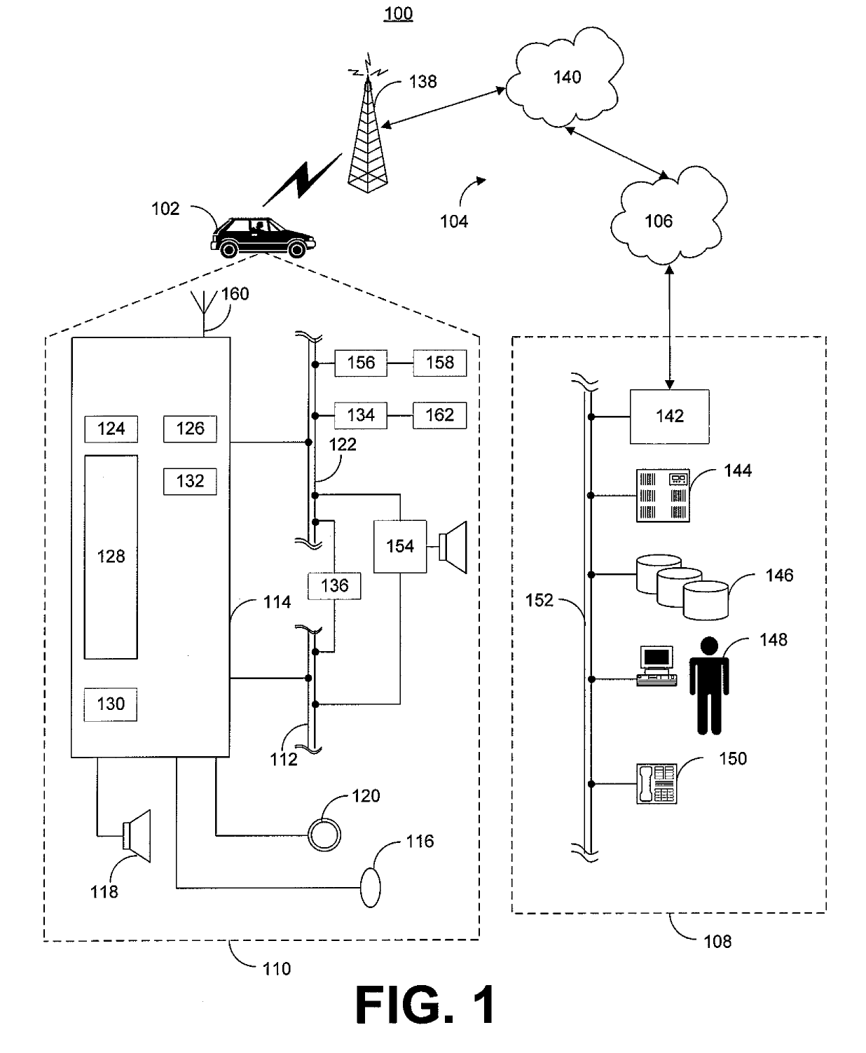

An exemplary environment in which the invention may operate is described hereinafter. It will be appreciated that the described environment is an example, and does not imply any limitation regarding the use of other environments to practice the invention. With reference to FIG. 1 there is shown an example of a communication system 100 that may be used with the present method and system and generally includes a vehicle 102, a wireless carrier system 104, a land network 106 and a call center 108. It should be appreciated that the overall architecture, setup and operation, as well as the individual components of a system such as that shown here are generally known in the art. Thus, the following paragraphs simply provide a brief overview of one such exemplary information system 100; however, other systems not shown here could employ the present method as well.

Vehicle 102 is preferably a mobile vehicle such as a motorcycle, car, truck, recreational vehicle (RV), boat, plane, etc., and is equipped with suitable hardware and software that enables it to communicate over system 100. Some of the vehicle hardware 110 is shown generally in FIG. 1 including a telematics unit 114, a microphone 116, a speaker 118 and buttons and/or controls 120 connected to the telematics unit 114. Operatively coupled to the telematics unit 114 is a network connection or vehicle bus 122. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few.

The telematics unit 114 is an onboard device that provides a variety of services through its communication with the call center 108, and generally includes an electronic processing device 128 one or more types of electronic memory 130, a cellular chipset/component 124, a wireless modem 126, a dual antenna 160 and a navigation unit containing a GPS chipset/component 132. In one example, the wireless modem 126 is comprised of a computer program and/or set of software routines executing within processing device 128. The cellular chipset/component 124 and the wireless modem 126 may be called the network access device (NAD) of the telematics unit 114.

The telematics unit 114, through the electronic processing device 128 and one or more types of electronic memory 130, may be capable of storing information regarding a subscriber's account, such as various tolling options and payment plans available to the subscriber, and may also be capable of processing the tolling of the subscriber's account when the telematics unit is providing service to a user. The telematics unit 114 may also be capable of generating a hierarchy of tolling options based on the subscriber's information, or alternatively, may be capable of receiving information regarding a hierarchy predetermined by the TSP. The telematics unit 114 may further communicate with a network service provider through the cellular chipset/component 124 and the wireless modem 126 such that the network service provider processes the tolling of the subscriber's account.

The telematics unit 114 provides too many services to list them all, but several examples include: turn-by-turn directions and other navigation-related services provided in conjunction with the GPS based chipset/component 132; airbag deployment notification and other emergency or roadside assistance-related services provided in connection with various crash and or collision sensor interface modules 156 and sensors 158 located throughout the vehicle. Infotainment-related services where music, Web pages, movies, television programs, video games and/or other content is downloaded by an infotainment center 136 operatively connected to the telematics unit 114 via vehicle bus 122 and audio bus 112. In one example, downloaded content is stored for current or later playback.

Again, the above-listed services are by no means an exhaustive list of all the capabilities of telematics unit 114, as should be appreciated by those skilled in the art, but are simply an illustration of some of the services that the telematics unit 114 is capable of offering. It is anticipated that telematics unit 114 include a number of known components in addition to those listed above.

Vehicle communications preferably use radio transmissions to establish a voice channel with wireless carrier system 104 so that both voice and data transmissions can be sent and received over the voice channel. Vehicle communications are enabled via the cellular chipset/component 124 for voice communications and a wireless modem 126 for data transmission. In order to enable successful data transmission over the voice channel, wireless modem 126 applies some type of encoding or modulation to convert the digital data so that it can communicate through a vocoder or speech codec incorporated in the cellular chipset/component 124. Any suitable encoding or modulation technique that provides an acceptable data rate and bit error can be used with the present method. Dual mode antenna 160 services the GPS chipset/component and the cellular chipset/component.

Microphone 116 provides the driver or other vehicle occupant with a means for inputting verbal or other auditory commands, and can be equipped with an embedded voice processing unit utilizing a human/machine interface (HMI) technology known in the art. Conversely, speaker 118 provides verbal output to the vehicle occupants and can be either a stand-alone speaker specifically dedicated for use with the telematics unit 114 or can be part of a vehicle audio component 154. In either event, microphone 116 and speaker 118 enable vehicle hardware 110 and call center 108 to communicate with the occupants through audible speech. The vehicle hardware also includes one or more buttons or controls 120 for enabling a vehicle occupant to activate or engage one or more of the vehicle hardware components 110. For example, one of the buttons 120 can be an electronic push button used to initiate voice communication with call center 108 (whether it be a live advisor 148 or an automated call response system). In another example, one of the buttons 120 can be used to initiate emergency services.

The audio component 154 is operatively connected to the vehicle bus 122 and the audio bus 112. The audio component 154 receives analog information, rendering it as sound, via the audio bus 112. Digital information is received via the vehicle bus 122. The audio component 154 provides AM and FM radio, CD, DVD, and multimedia functionality independent of the infotainment center 136. Audio component 154 may contain a speaker system, or may utilize speaker 118 via arbitration on vehicle bus 122 and/or audio bus 112.

The vehicle crash and/or collision detection sensor interface 156 are operatively connected to the vehicle bus 122. The crash sensors 158 provide information to the telematics unit 114 via the crash and/or collision detection sensor interface 156 regarding the severity of a vehicle collision, such as the angle of impact and the amount of force sustained.

Vehicle sensors 162, connected to various sensor interface modules 134 are operatively connected to the vehicle bus 122. Example vehicle sensors include but are not limited to gyroscopes, accelerometers, magnetometers, emission detection and/or control sensors, and the like. Example sensor interface modules 134 include power train control, climate control, and body control, to name but a few.

Wireless carrier system 104 is preferably a cellular telephone system or any other suitable wireless system that transmits signals between the vehicle hardware 110 and land network 106. According to an example, wireless carrier system 104 includes one or more cell towers 138, base stations and/or mobile switching centers (MSCs) 140, as well as any other networking components required to connect the wireless system 104 with land network 106. A component in the mobile switching center may include a remote data server 144.

As appreciated by those skilled in the art, various cell tower/base station/MSC arrangements are possible and could be used with wireless system 104. For example, a base station and a cell tower could be co-located at the same site or they could be remotely located, and a single base station could be coupled to various cell towers or various base stations could be coupled with a single MSC, to but a few of the possible arrangements. Preferably, a speech codec or vocoder is incorporated in one or more of the base stations, but depending on the particular architecture of the wireless network, it could be incorporated within a Mobile Switching Center or some other network components as well.

Land network 106 can be a conventional land-based telecommunications network that is connected to one or more landline telephones and connects wireless carrier network 104 to call center 108. For example, land network 106 can include a public switched telephone network (PSTN) and/or an Internet protocol (IP) network, as is appreciated by those skilled in the art. Of course, one or more segments of the land network 106 can be implemented in the form of a standard wired network, a fiber or other optical network, a cable network, other wireless networks such as wireless local networks (WLANs) or networks providing broadband wireless access (BWA), or any combination thereof.

Call Center (OCC) 108 is designed to provide the vehicle hardware 110 with a number of different system back-end functions and, according to the example shown here, generally includes one or more switches 142, servers 144, databases 146, live advisors 148, as well as a variety of other telecommunication and computer equipment 150 that is known to those skilled in the art. These various call center components are preferably coupled to one another via a network connection or bus 152, such as the one previously described in connection with the vehicle hardware 110. Switch 142, which can be a private branch exchange (PBX) switch, routes incoming signals so that voice transmissions are usually sent to either the live advisor 148 or an automated response system, and data transmissions are passed on to a modem or other piece of equipment 150 for demodulation and further signal processing.

The modem 150 preferably includes an encoder, as previously explained, and can be connected to various devices such as a server 144 and database 146. For example, database 146 could be designed to store subscriber profile records, subscriber behavioral patterns, or any other pertinent subscriber information. Although the illustrated example has been described as it would be used in conjunction with a manned call center 108, it will be appreciated that the call center 108 can be any central or remote facility, manned or unmanned, mobile or fixed, to or from which it is desirable to exchange voice and data.

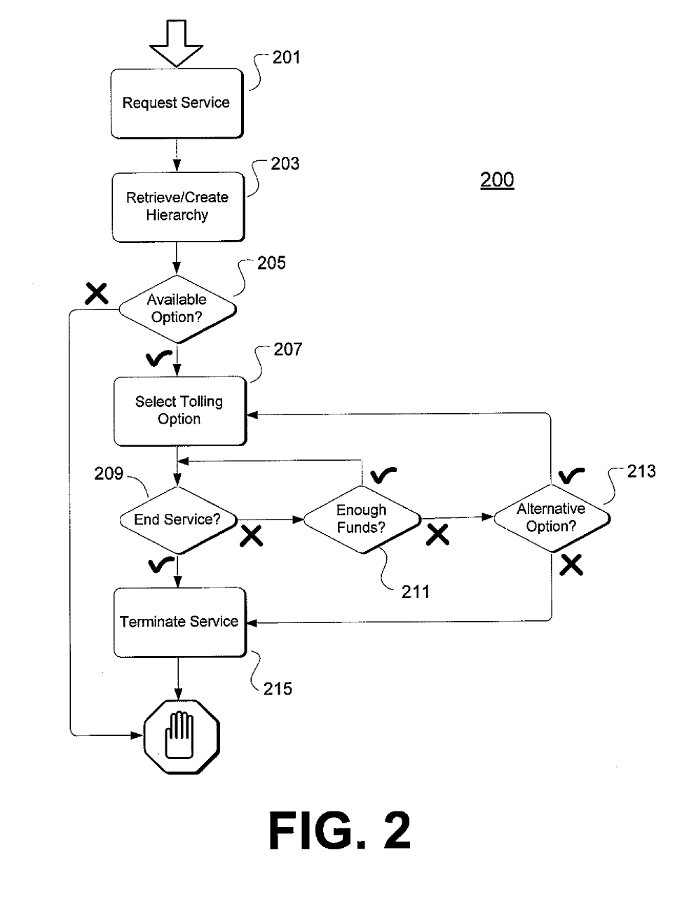

As noted above, the telematics unit 114 and associated components are associated in an implementation of the invention with a vehicle 102. With further reference to the architecture of FIG. 1, and turning more specifically to FIG. 2, a process is depicted through which a telematics unit 114 may handle the switching between various tolling options part of a hierarchy of tolling options. Examples of tolling options include and are not limited to: unlimited periodic subscriptions, free trial subscriptions, free subscription minutes, prepaid subscription minutes, postpaid subscription minutes, prepaid data allocation, and postpaid data allocation. Moreover, these tolling options may be implemented by the telematics unit and internally tolled, or implemented on a network through a network service provider and externally tolled. Furthermore, these tolling options may include different terms and policies, such as varying expiration dates, varying costs, methods of tolling, and handling of replenishment, breakage or transference. To give a particular example, a subscriber to a hands-free calling service may have the following tolling options available for the hands-free calling: a free trial of x amount of subscription minutes, y amount of prepaid telematics-based subscription minutes expiring on date A, z amount of prepaid telematics-based subscription minutes expiring on date B, v amount of prepaid network-based subscription minutes expiring on date C, and unlimited postpaid network-based subscription minutes. One skilled in the art will appreciate that many combinations and permutations of tolling options and payment plans for each type of telematics service is possible and that they are not limited to the specific implementations disclosed here.

A user of the telematics unit 114 may first request a telematics service 201, including but not limited to turn-by-turn navigation, emergency call handling, hands-free calling, media downloading, etc. One skilled in the art will appreciate that this service request 201 may take various different forms, including but not limited to the press of a button, a spoken command, an automatic trigger based on the fulfillment of some condition (e.g. requesting emergency call handling after an accident has been detected), and other methods of communicating a service request to the telematics unit 114.

In one implementation, the telematics unit 114 may retrieve a hierarchy of tolling options 203 from the TSP through communication with the call center 108. In an alternative implementation, the telematics unit 114 may generate a hierarchy of tolling options 203. One skilled in the art will appreciate that there are numerous variations and different implementations of ways for the telematics unit 114 to retrieve or generate a hierarchy including but not limited to those described herein. In one implementation, the TSP may predetermine a single hierarchy for all telematics services and communicate this hierarchy to the telematics units 114 through the call center 108. In another implementation, the TSP may predetermine a specific hierarchy corresponding to each telematics service and communicate these hierarchies to the telematics unit 114 through the call center 108. In either of these implementations when the TSP predetermines the hierarchy or hierarchies, one skilled in the art will appreciate that the hierarchy or hierarchies may be communicated to the telematics unit 114 before or after the user requests the telematics service. In yet another implementation, the telematics unit 114 may generate the hierarchy internally based on programming in the telematics unit 114. In yet another further implementation, the generated hierarchy may be based on information provided to the telematics unit 114 by the TSP (such as information regarding the tolling options such as costs and expiration dates; information regarding tolling options specifically available to the subscriber; the subscriber's preferences, etc.).

In these implementations, whether the hierarchy is generated internally by the telematics unit 114 or predetermined by the TSP, the hierarchy may be based on certain rules. The rules may include simple rules including but limited to unlimited subscriptions taking priority over subscription minutes tolling options, free trial subscription minutes taking priority over prepaid subscription minutes, subscription minutes with earlier expiration dates taking priority over subscription minutes with later expiration dates, prepaid taking priority over postpaid, telematics-based taking priority over network-based or network-based taking priority over telematics-based. The rules may also include more complex rules including but not limited to, for example, any unlimited subscription taking priority over a telematics-based pre-paid tolling option, which takes priority over a network-based pre-paid tolling option, which takes priority over a network-based postpaid tolling option, and so on.

The telematics unit 114 may also determine whether there are any available tolling options 205 before selecting a tolling option 207. One skilled in the art will appreciate that the determination of an available option or available options may be performed either before or after the hierarchy is generated or retrieved. In one implementation, the hierarchy or hierarchies provided by the TSP or generated by the telematics unit 114 are comprised only of tolling options available to the subscriber. In this implementation, possible tolling options that the subscriber has not subscribed to or have insufficient remaining balance are not included in the hierarchy of tolling options. In another implementation, the hierarchy or hierarchies may comprise tolling options unavailable to the subscriber, and the telematics unit 114 determines whether a potential tolling option in the hierarchy is available to the subscriber to toll the subscriber's account for the requested service. For example, the hierarchy may comprise as potential tolling options an unlimited monthly subscription, prepaid telematics-based subscription minutes, and postpaid network-based subscription minutes, and the subscriber has not subscribed to the unlimited monthly subscription but has a balance of prepaid telematics-based subscription minutes and is able to utilize postpaid network-based subscription minutes as well. In this example, the telematics unit 114 may determine that the highest priority tolling option available to the user is the prepaid telematics-based subscription minutes 205 and select that tolling option 207. In an alternative implementation, the telematics unit 114 may determine a list of the available tolling options 205 (i.e. prepaid telematics-based subscription minutes and postpaid network-based subscription minutes) and select the highest item on the list 207.

After a first tolling option has been selected 207, the telematics unit 114 tolls the subscriber's account according to the first tolling option and monitors whether the account retains sufficient balance to maintain provision of the service 211 until that tolling option is no longer viable 211 or until an end service request is received 209 (i.e. the user stops the service, the service is completed, or the service is automatically ended based on a trigger). One skilled in the art will appreciate that the end service request may take one of many forms, including but not limited to the user pressing a button, the user speaking a command, a requested service being completed (e.g. a media download finishing or a user arriving at a destination), or another trigger indicating that the tolling for the service should be ended (e.g. an other party hanging up the phone in the context of hands-free calling or emergency call handling). If the telematics unit 114 receives such an end service request, the telematics unit 114 may terminate the provision of the service 215.

If no end service request is received, the telematics unit 114 may continue to monitor whether the subscriber's account retains sufficient balance to maintain provision of the service 211. One skilled in the art will appreciate that certain tolling options do not requiring monitoring by the telematics unit 114, such as a postpaid tolling option wherein no limit exists to the amount of subscription minutes the user may toll. One skilled in the art will also appreciate that in certain implementations, the monitoring by the telematics unit 114 may comprise receiving information from a network, such as with a prepaid network-based tolling option wherein the network service provider may communicate to the telematics unit 114 when the subscriber's account has run out of subscription minutes. As long as the first tolling option continues to be viable for providing service to the customer (e.g. an unlimited subscription has not reached its end date, unexpired prepaid subscription minutes remain, postpaid tolling available, etc.), the subscriber's account may continue to be tolled according to that the first tolling option.

If the first tolling option is no longer viable (e.g. the unlimited subscription has ended, the subscriber runs out of subscription minutes, etc.), the telematics unit 114 may determine whether an alternative tolling option is available 213. In one implementation, the telematics unit 114 may use a previously generated or retrieved hierarchy that may or may not include unavailable tolling options, determine what the next available tolling option is 213, and select that tolling option 207. In another implementation, the telematics unit 114 may use a previously generated list of available tolling options 213 and select the next tolling option on that list 207. One skilled in the art will appreciate that the methods for selecting a second tolling option disclosed herein are merely examples of implementations and do not exclude other methods of selecting a second available tolling option.

If the telematics unit 114 determines that no alternative tolling options can be utilized, the telematics unit 114 may terminate the provision of service 215. If the telematics unit 114 determines an alternative tolling option exists and is next on the hierarchy of tolling options, the telematics unit 114 may switch the tolling for the service from the first option to the next option without interrupting the provision of service to the user. In a further implementation, the telematics unit 114 may communicate to the user that it is performing the switch from one tolling option to another tolling option, and may further communicate what the another tolling option is. In yet another further implementation, the telematics unit 114 may provide the user with an option to decline to switch to the another tolling option. For example, in some instances, it may be expensive to use a certain tolling option for a certain service, such as using the subscriber's data allocation to handle a hands-free call, and the user may prefer to terminate the provision of service rather than allow the telematics unit 114 to begin tolling under the alternative tolling option.

In a further implementation, this process of selecting a new tolling option 207, monitoring the viability of the new tolling option 211, and transitioning to another tolling option 213 and 207 may be repeated whenever the current tolling option becomes unviable and an alternative available tolling option exists, until the telematics unit 114 receives an end service request 209 or no alternative tolling options remain 213.

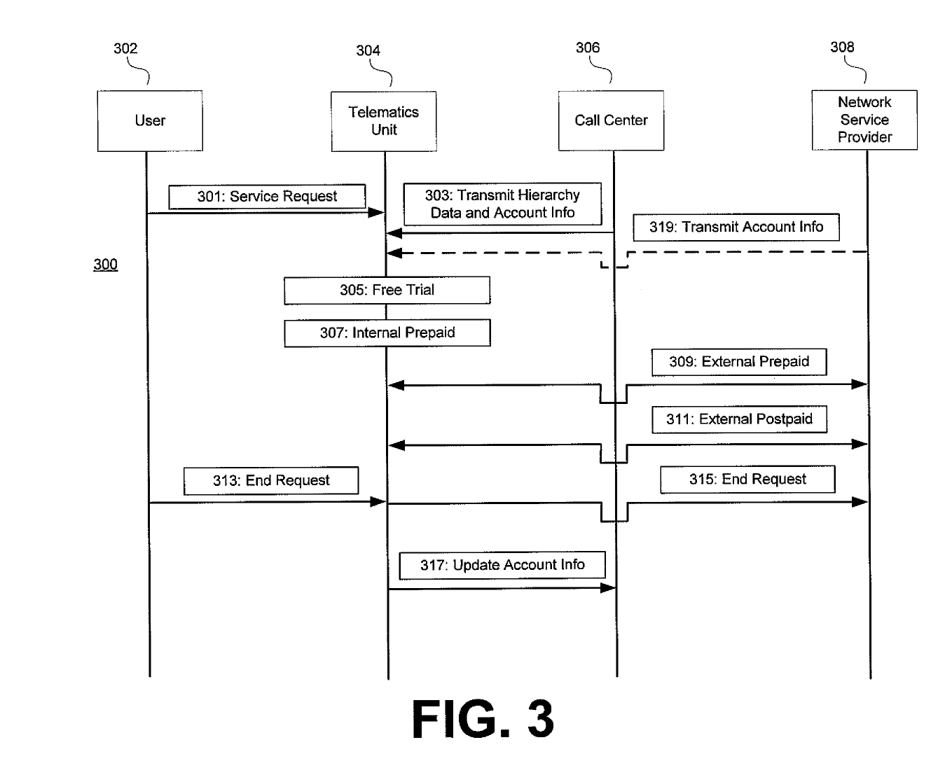

With further reference to the architecture of FIG. 1, and turning more specifically to FIG. 3, one specific implementation is depicted wherein a user 302 of the telematics unit requests a particular service and the telematics unit 304 (114) switches between multiple tolling options until an end request is received. In this particular example, the user requests a hands-free calling service 301. The telematics unit 304 retrieves a hierarchy 303 predetermined by the TSP from the call center 306 (108) along with other information pertaining to the subscriber's account including but not limited to the tolling options available to the subscriber and the status or balance of the subscriber's account corresponding to each of the tolling options. In this example, the hierarchy of tolling options retrieved is as follows, from highest priority to lowest priority: free trial subscription minutes, unlimited monthly subscription, telematics-based prepaid subscription minutes, network-based prepaid subscription minutes, and postpaid network-based subscription minutes. The telematics unit 304 further determines that the subscriber has 30 free trial subscription minutes, has not subscribed to the monthly unlimited subscription, has 10 telematics-based prepaid subscription minutes, has 20 network-based prepaid subscription minutes, and that postpaid network-based subscription minutes are available as a tolling option.

In a further implementation, the network service provider 308, rather than the call center 306, may store information regarding the subscriber's network-based prepaid and postpaid subscription minutes, and the network service provider 308 may communicate this information 319 to the telematics unit 304 or to the call center 306. One skilled in the art will appreciate that this communication may occur early in the process, e.g., before the telematics unit 304 determines a first plan to select, or this communication may occur later in the process such as only when the telematics unit 304 actually attempts to utilize a network-based tolling option 309, 311.

Assuming, in this example, that the user makes a hands-free call lasting 120 minutes, the telematics unit 304 first tolls the subscriber's 30 free trial subscription minutes 305, and then tolls the subscriber's 10 telematics-based prepaid subscription minutes 307. Next, the telematics unit 304 communicates with the network service provider 308 to toll the subscriber's 20 network-based prepaid subscription minutes 309 and toll 60 postpaid network-based postpaid subscription minutes 311, adding up to a total of 120 minutes tolled. The user 302 hangs up the call after 120 minutes 313, and the wireless network provider stops tolling postpaid network-based subscription minutes 315. In a further implementation, the telematics unit 304 may update the call center 306 regarding the subscriber's current account information 317 such that the call center's records of the subscriber's account information reflects the tolling that took place during the provision of the telematics service to the user 302.

In yet another further implementation, the telematics unit 304 may notify the user 302 each time it selects a new tolling option (e.g. before tolling according to any of the options 305, 307, 309 and 311), and may further provide the user with a choice to decline the selection. In yet another further implementation, the TSP may designate a certain tolling options or multiple options as “default” tolling options such that the telematics unit 304 may select any of the default tolling options without user approval. This may be desirable so that the consumer is not inconvenienced with having to approve every tolling option, but the consumer retains the ability to decline certain undesirable or less cost-effective tolling options.

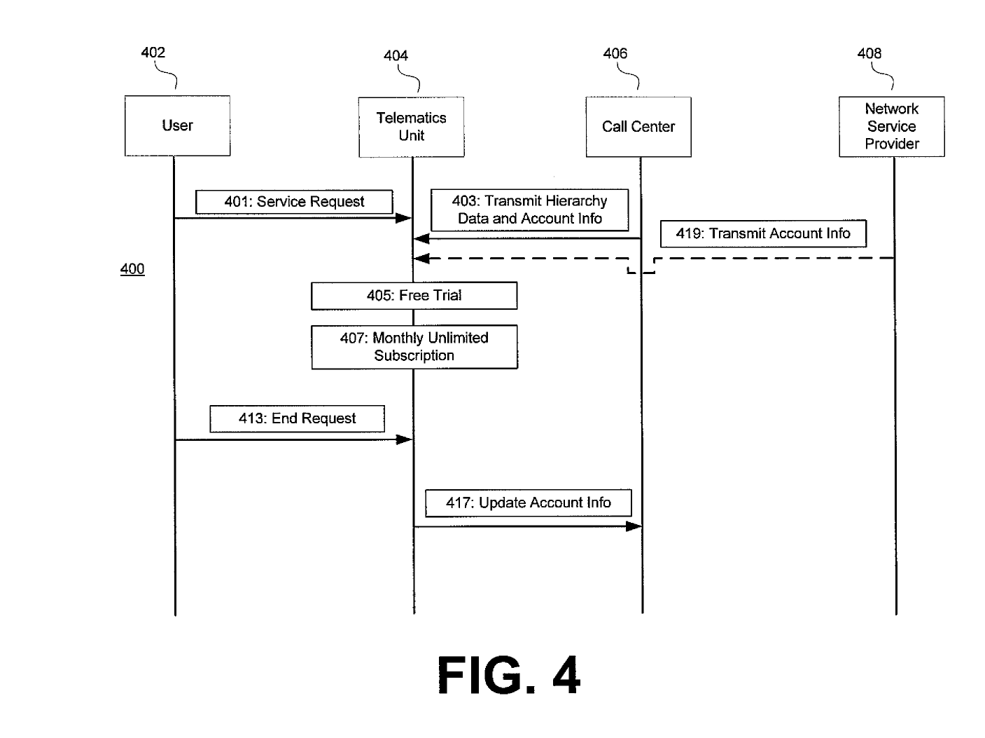

With further reference to the architecture of FIG. 1, and turning more specifically to FIG. 4, another specific implementation is depicted wherein a user 402 of the telematics unit requests a particular service and the telematics unit 404 (114) switches between multiple tolling options until an end request is received. In the example of FIG. 4, the user 402 again requests a hands-free call and the hierarchy of tolling options retrieved is the same as the hierarchy of the example in FIG. 3, where from highest priority to lowest priority the tolling options are: free trial subscription minutes, unlimited monthly subscription, telematics-based prepaid subscription minutes, network-based prepaid subscription minutes, and postpaid network-based subscription minutes. However, in the example of FIG. 4, the telematics unit 404 further determines that the subscriber has subscribed to the monthly unlimited subscription, in addition to the 30 free trial subscription minutes, 10 telematics-based prepaid subscription minutes, 20 network-based prepaid subscription minutes, and the available postpaid network-based subscription minutes.

Assuming, in the example of FIG. 4, that the user 402 again makes a hands-free call lasting 120 minutes, the telematics unit 404 first tolls the 30 free subscription minutes, then switches to tolling the unlimited monthly subscription. Further assuming the unlimited monthly subscription does not expire during the 90 minutes that the unlimited monthly subscription tolling option is utilized, the telematics unit 404 maintains the call based on the unlimited monthly subscription tolling option until the user completes the call 413. Thus, in the example of FIG. 4, the telematics unit 404 does not switch to the internal telematics-based prepaid, external network-based prepaid, or external network-based postpaid subscription minutes tolling options and does not deduct any of those types of funds from the subscriber's account.

It will be appreciated by one skilled in the art that FIG. 3 and FIG. 4 represent specific implementations of the present invention, and the disclosure relating more generally to FIG. 2 may be applied to provide many variations of the particular processes utilized in the implementations depicted by FIG. 3 and FIG. 4. One skilled in the art would readily be able to apply the teachings relating to FIG. 2-4 to different possible specific telematics-based services provided by a TSP utilizing various different possible tolling options and payment plans.

It will be appreciated that the described a system and method provide for the efficient and effective processing of hierarchical selecting and switching between tolling options associated with a telematics service and tolling a subscriber's account accordingly such that the provision of telematics service to a user of the telematics unit is uninterrupted if possible and the optimal tolling option is utilized. It will also be appreciated, however, that the foregoing methods and implementations are merely examples of the inventive principles, and that these illustrate only preferred techniques.

It is thus contemplated that other implementations of the invention may differ in detail from foregoing examples. As such, all references to the invention are intended to reference the particular example of the invention being discussed at that point in the description and are not intended to imply any limitation as to the scope of the invention more generally. All language of distinction and disparagement with respect to certain features is intended to indicate a lack of preference for those features, but not to exclude such from the scope of the invention entirely unless otherwise indicated.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for processing a hierarchy of tolling options for the provision of a telematics service to a user of a telematics unit, the method comprising:
receiving, at the telematics unit, a request from the user to provide a telematics service to the user;
receiving, at the telematics unit, account information regarding the account of a subscriber to the telematics service;
determining, at the telematics unit, at least one available tolling option based on the account information of the subscriber and based on a hierarchy of tolling options;
selecting, at the telematics unit, a first tolling option from the hierarchy of tolling options; and
providing, at the telematics unit, the requested service based on the selected first tolling option.

2. The method of claim 1, the method further comprising:
retrieving, at the telematics unit, a predetermined hierarchy of tolling options from a call center.

3. The method of claim 2, wherein the predetermined hierarchy of tolling options corresponds to a specific telematics service.

4. The method of claim 1, the method further comprising:
generating, at the telematics unit, a hierarchy of tolling options based on the requested service.

5. The method of claim 4, wherein the generating the hierarchy of tolling options is based on at least one factor from the group consisting of:
whether the tolling options are telematics-based or network-based;
whether the tolling options are prepaid or postpaid;
the type of payment plan associated with the tolling option;
relative expiration dates of the tolling options; and
availability of the tolling option.

6. The method of claim 1, the method further comprising:
determining, at the telematics unit, whether an other tolling option is available;
transitioning, at the telematics unit, from one tolling option to the other tolling option when the current tolling option is no longer viable to maintain provision of the requested service, if the other tolling option is available; and
providing, at the telematics unit, the requested service based on the other tolling option.

7. The method of claim 6, wherein the other tolling option is the next available tolling option with the next highest priority in the hierarchy of tolling options.

8. The method of claim 7, wherein the one tolling option is a telematics-based tolling option and the other tolling option is a network-based tolling option.

9. The method of claim 7, wherein the one tolling option is a prepaid tolling option and the other tolling option is a postpaid tolling option.

10. The method of claim 7, wherein the one tolling option and the other tolling option are subscription minutes with different expiration dates.

11. The method of claim 7, wherein at least one of the one tolling option and the other tolling option is at least one of a free trial unlimited subscription for a set duration and an amount of free trial subscription minutes.

12. The method of claim 7, wherein the said transitioning, at the telematics unit, from one tolling option to the other tolling option further comprises:
communicating, at the telematics unit, to the user that the telematics unit is transitioning from the one tolling option to the other tolling option.

13. The method of claim 12, wherein the said transitioning, at the telematics unit, from one tolling option to the other tolling option further comprises:
providing, at the telematics unit, the user with a choice to complete the transition or not;
terminating, at the telematics unit, the provision of the requested service if the user chooses not to complete the transition.

14. The method of claim 1, the method further comprising:
transmitting, from the telematics unit, updated account information regarding the account of the subscriber after the provision of the requested service is discontinued.

15. A method for processing a hierarchy of tolling options for the provision of a telematics service to a user of a telematics unit, the method comprising:
storing, at a call center, account information regarding the account of a subscriber to the telematics service;
generating, at the call center, a hierarchy of tolling options;
transmitting, at the call center, the account information regarding the subscriber's account and the hierarchy of tolling options to the telematics unit.

16. The method of claim 15, wherein the predetermined hierarchy of tolling options corresponds to a specific telematics service.

17. The method of claim 16, wherein the generating the hierarchy of tolling options is based on at least one factor from the group consisting of:
whether the tolling options are telematics-based or network-based;
whether the tolling options are prepaid or postpaid;
the type of payment plan associated with the tolling option;
relative expiration dates of the tolling options; and
availability of the tolling option.

18. The method of claim 15, the method further comprising:
receiving, at the call center, updated account information from the telematics unit regarding the account of the subscriber after the provision of the requested service is discontinued.

19. A system for processing a hierarchy of tolling options for the provision of a telematics service, the system comprising:
a vehicle equipped with a telematics unit; and
the telematics unit, adapted to send and receive information to and from a call center and a network service provider, to select between available tolling options based on a hierarchy of tolling options, to process telematics-based tolling, and to provide telematics services to a user of the telematics unit.

20. The system of claim 19, the system wherein the call center is adapted to store information regarding a subscriber's account and to send and receive information to and from a telematics unit, and the network service provider is adapted to send and receive information to and from a telematics unit, to process network-based tolling, and to provide telematics service through the telematics unit.
